(19) United States
(12) Patent Application Publication
(10) Pub. No.: US 2025/0357615 A1
(43) Pub. Date: Nov. 20, 2025

(54) ELECTRIC POWER STORAGE APPARATUS

(71) Applicant: TOYOTA JIDOSHA KABUSHIKI KAISHA, Toyota-shi (JP)

(72) Inventors: Shigeyuki INOUE, Toyota-shi (JP); Kazuki SUGIE, Miyoshi-shi (JP); Yuki TAKKAHASHI, Miyoshi-shi (JP)

(73) Assignee: TOYOTA JIDOSHA KABUSHIKI KAISHA, Toyota-shi (JP)

(21) Appl. No.: 19/052,651

(22) Filed: Feb. 13, 2025

(30) Foreign Application Priority Data
May 15, 2024 (JP) 2024-079525

(51) Int. Cl. H01M 50/317; H01M 50/209; H01M 50/289

(52) U.S. Cl. CPC H01M 50/317; H01M 50/209; H01M 50/289; H01M 2200/20

(57) ABSTRACT

An electric power storage apparatus includes: a plurality of first electric power storage stacks; a plurality of second electric power storage stacks; a case; and a pressure relief valve. The case includes a case body and a partition wall. The partition wall partitions the inside of the case body into an accommodation chamber and a non-accommodation chamber. The partition wall includes a contact end face configured to come into contact with the inner surface of the case body, and an opening. The pressure relief valve is provided at a portion of the non-accommodation chamber. The portion faces the opening in the first direction.

### CROSS-REFERENCE TO RELATED APPLICATION

This application claims priority to Japanese Patent Application No. 2024-079525 filed on May 15, 2024, incorporated herein by reference in its entirety.

### BACKGROUND

### 1. Technical Field

The present disclosure relates to an electric power storage apparatus.

### 2. Description of Related Art

For example, Japanese Unexamined Patent Application Publication (Translation of PCT application) No. 2022-516519 (JP-2022-516519 A) discloses a power battery pack including a plurality of battery cells, a battery tray that accommodates the battery cells, and a cover plate connected to the battery tray. The battery cells include a first battery cell group and a second battery cell group disposed side by side along the long-side direction of the battery tray. The first battery cell group and the second battery cell group are disposed at an interval in the short-side direction of the battery tray.

### SUMMARY

It is desirable that gas discharged from any of the electric power storage cells in the electric power storage apparatus as described in JP-2022-516519 A reaches a pressure relief valve through a desired path.

An object of the present disclosure is to provide an electric power storage apparatus that makes it possible to restrict a path of gas toward a pressure relief valve.

An electric power storage apparatus according to an aspect of the present disclosure includes: a plurality of first electric power storage stacks disposed side by side along a first direction; a plurality of second electric power storage stacks disposed side by side along the first direction to face the first electric power storage stacks in a second direction orthogonal to both the first direction and the up-down direction; a case configured to accommodate the first electric power storage stacks and the second electric power storage stacks; and a pressure relief valve provided in the case. The case includes a case body configured to accommodate the first electric power storage stacks and the second electric power storage stacks, and a partition wall provided in the case body. The partition wall faces the first electric power storage stacks and the second electric power storage stacks in the first direction. The partition wall partitions the inside of the case body into an accommodation chamber in which the first electric power storage stacks and the second electric power storage stacks are disposed and a non-accommodation chamber in which the first electric power storage stacks and the second electric power storage stacks are not disposed. The partition wall includes a contact end face configured to come into contact with the inner surface of the case body, and an opening formed at a position facing a space in the first direction. The space is located between the first electric power storage stacks and the second electric power storage stacks. The pressure relief valve is provided at a portion of the non-accommodation chamber. The portion faces the opening in the first direction.

According to the present disclosure, it is possible to provide an electric power storage apparatus that makes it possible to restrict a path of gas toward a pressure relief valve.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of an electric power storage apparatus according to an embodiment of the present disclosure;

FIG. 2 is a schematic perspective view of the electric power storage apparatus illustrated in FIG. 1 with an upper cover detached from the electric power storage apparatus;

FIG. 3 is a schematic plan view of the electric power storage apparatus with the upper cover and a covering plate detached from the electric power storage apparatus; and

FIG. 4 is a sectional view taken along a line IV-IV in FIG. 3.

### DETAILED DESCRIPTION OF EMBODIMENTS

An embodiment of the present disclosure will be described with reference to the drawings. Note that the drawings referred to below denote the same or equivalent members by the same reference sign.

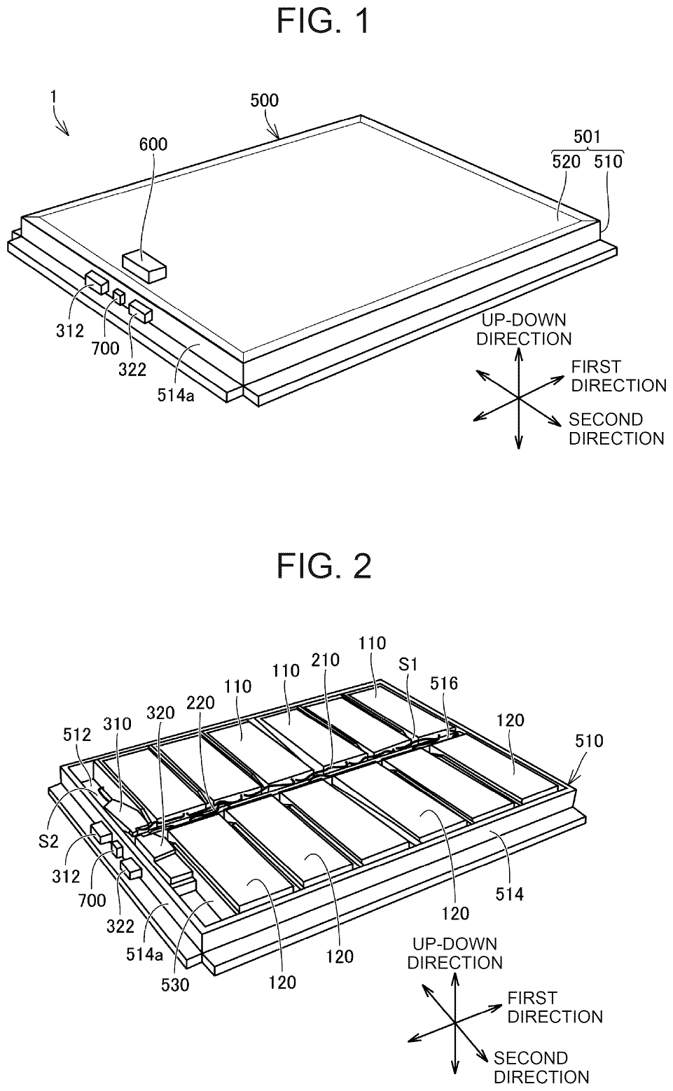

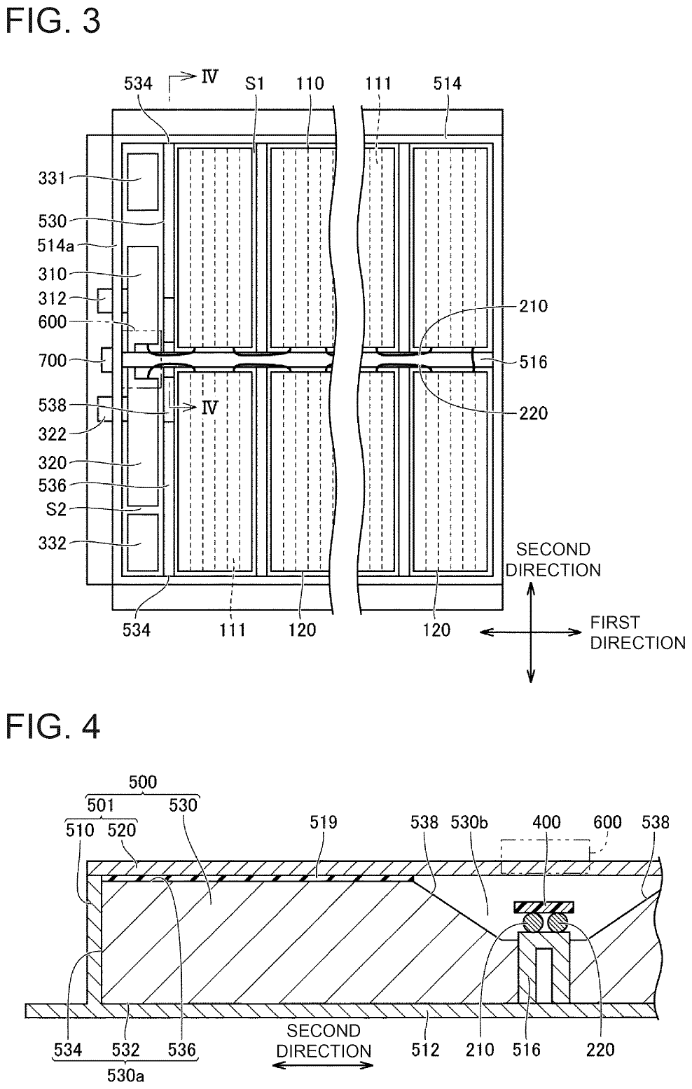

FIG. 1 is a schematic perspective view of an electric power storage apparatus according to an embodiment of the present disclosure. FIG. 2 is a schematic perspective view of the electric power storage apparatus illustrated in FIG. 1 with an upper cover detached from the electric power storage apparatus. FIG. 3 is a schematic plan view of the electric power storage apparatus with the upper cover and a covering plate detached from the electric power storage apparatus. FIG. 4 is a sectional view taken along a line IV-IV in FIG. 3. An electric power storage apparatus 1 is mounted, for example, on the bottom of a vehicle.

As illustrated in FIG. 1 to FIG. 4, the electric power storage apparatus 1 includes a plurality of first electric power storage stacks 110, a plurality of second electric power storage stacks 120, a first bus bar 210, a second bus bar 220, a first junction box 310, a second junction box 320, a first electronic device 331, a second electronic device 332, a covering plate 400, a case 500, a pressure relief valve 600, and a respiratory membrane 700. Note that FIG. 2 does not illustrate the first electronic device 331, the second electronic device 332, and the covering plate 400 and FIG. 3 does not illustrate the covering plate 400.

The first electric power storage stacks 110 are disposed side by side in a first direction. In the present embodiment, the first electric power storage stacks 110 include the six first electric power storage stacks 110. The number of first electric power storage stacks 110 is not, however, limited to six. Each of the first electric power storage stacks 110 is formed to have a rectangular-parallelepiped shape that is longer in a second direction orthogonal to both the first direction and the up-down direction.

Each of the first electric power storage stacks 110 includes a plurality of electric power storage cells 111 (see FIG. 3). The electric power storage cells 111 are disposed side by side, for example, in the first direction. Note that the electric power storage cells 111 may be disposed side by side in the second direction. Each of the electric power storage cells 111 is formed to have a flat rectangular-parallelepiped shape. Examples of each electric power storage cell 111 include a lithium-ion battery. Each electric power storage cell 111 may include an all-solid-state battery including a solid electrolyte. Each electric power storage cell 111 may include a safety valve provided at a position facing an upper cover 520, that is, on the upper surface of the housing of the electric power storage cell 111.

The second electric power storage stacks 120 are disposed side by side in the first direction to face the first electric power storage stacks 110 in the second direction. In the present embodiment, the second electric power storage stacks 120 include the six second electric power storage stacks 120. The number of second electric power storage stacks 120 is not, however, limited to six. The configuration of each of the second electric power storage stacks 120 is the same as the configuration of the first electric power storage stack 110.

The first bus bar 210 connects the pair of first electric power storage stacks 110 adjacent to each other in the first direction. The first bus bar 210 is arranged in a routing space between the first electric power storage stacks 110 and the second electric power storage stacks 120.

The second bus bar 220 connects the pair of second electric power storage stacks 120 adjacent to each other in the first direction. The second bus bar 220 is arranged in the routing space.

The first junction box 310 is disposed at a position facing, in the first direction, the first electric power storage stack 110 that is disposed the closest of the first electric power storage stacks 110 to the outside in the first direction (e.g., the front side of a vehicle in the front-rear direction of the vehicle). The first junction box 310 accommodates a relay, a fuse, and the like. The first junction box 310 includes a first connector 312. The first connector 312 protrudes outward in the first direction.

The second junction box 320 is disposed at a position facing the second electric power storage stack 120 in the first direction and facing the first junction box 310 at an interval in the second direction. The second junction box 320 accommodates a relay, a fuse, and the like. As illustrated in FIG. 2, the outer shape of the second junction box 320 is larger than the outer shape of the first junction box 310 in the present embodiment. The second junction box 320 includes a second connector 322. The second connector 322 protrudes outward in the first direction.

As illustrated in FIG. 3, the first electronic device 331 is disposed outside the first junction box 310 in the second direction. The second electronic device 332 is disposed outside the second junction box 320 in the second direction.

As illustrated in FIG. 4, the covering plate 400 covers the first bus bar 210 and the second bus bar 220 from above. The covering plate 400 is disposed in the routing space between the first electric power storage stacks 110 and the second electric power storage stacks 120. The covering plate 400 extends along the first direction. The covering plate 400 is formed to have a flat-plate shape. The covering plate 400 includes an insulating member. The covering plate 400 includes, for example, mica obtained by solidifying natural inorganic mineral substances by hot pressing. The covering plate 400 has a function of preventing gas erupting upward from any of the electric power storage stacks from coming into contact with the respective bus bars 210, 220.

The case 500 accommodates the first electric power storage stacks 110, the second electric power storage stacks 120, the first bus bar 210, the second bus bar 220, the first junction box 310, the second junction box 320, the first electronic device 331, the second electronic device 332, and the covering plate 400. The case 500 includes a case body 501 and a partition wall 530.

The case body 501 accommodates the first electric power storage stacks 110, the second electric power storage stacks 120, the first bus bar 210, the second bus bar 220, the first junction box 310, the second junction box 320, the first electronic device 331, the second electronic device 332, and the covering plate 400. The case body 501 includes a lower case 510 and the upper cover 520.

The lower case 510 opens upward. The lower case 510 includes a bottom wall 512, a peripheral wall 514, and a partition section 516.

The bottom wall 512 supports the respective electric power storage stacks 110, 120.

The peripheral wall 514 stands from the peripheral section of the bottom wall 512. The peripheral wall 514 surrounds the first electric power storage stacks 110 and the second electric power storage stacks 120. The peripheral wall 514 is formed to have a substantially quadrangular-tube shape.

The peripheral wall 514 includes a sidewall 514a formed on the opposite side (the left side in FIG. 3) of the first junction box 310 and the second junction box 320 from the side of the first junction box 310 and the second junction box 320 on which the first electric power storage stacks 110 and the second electric power storage stacks 120 are disposed. The sidewall 514a extends along the second direction.

The partition section 516 partitions the first electric power storage stacks 110 and the second electric power storage stacks 120. The partition section 516 has a shape extending along the first direction. The height of the partition section 516 is less than the height of the peripheral wall 514. As illustrated in FIG. 4, the routing space is formed between the partition section 516 and the covering plate 400.

The upper cover 520 accommodates the first electric power storage stacks 110, the second electric power storage stacks 120, the first bus bar 210, the second bus bar 220, the first junction box 310, the second junction box 320, the first electronic device 331, the second electronic device 332, and the covering plate 400 along with the lower case 510. The peripheral section of the upper cover 520 is fixed to the upper end of the peripheral wall 514 by a bolt or the like. The upper surface of the first junction box 310 and the upper surface of the second junction box 320 are in contact with the upper cover 520.

The partition wall 530 is provided in the case body 501. The partition wall 530 faces the first electric power storage stacks 110 and the second electric power storage stacks 120 in the first direction. The partition wall 530 partitions the inside of the case body 501 into an accommodation chamber S1 and a non-accommodation chamber S2. The first electric power storage stacks 110 and the second electric power storage stacks 120 are disposed in the accommodation chamber S1. The first electric power storage stacks 110 and the second electric power storage stacks 120 are not disposed in the non-accommodation chamber S2. The partition wall 530 extends in the second direction.

The first junction box 310 is disposed at a position facing the first electric power storage stack 110 in the first direction across the partition wall 530 in the non-accommodation chamber S2. The second junction box 320 is disposed at a position facing the second electric power storage stack 120 in the first direction across the partition wall 530 in the non-accommodation chamber S2.

As illustrated in FIG. 4, the partition wall 530 includes a contact end face 530a and an opening 530b.

The contact end face 530a is in contact with the inner surface of the case body 501. The contact end face 530a includes a lower end face 532, a side end face 534, and an upper end face 536.

The lower end face 532 is connected to the bottom wall 512 by welding or the like.

The side end face 534 is connected to the peripheral wall 514 by welding or the like.

As illustrated in FIG. 4, the upper end face 536 is connected to the upper cover 520 with a bonding member 519 in between. The upper end face 536 may be connected to the upper cover 520 by welding or the like.

The opening 530b is formed at a position facing the space (routing space) between the first electric power storage stacks 110 and the second electric power storage stacks 120 in the first direction. In the present embodiment, the partition wall 530 includes a pair of definition surfaces 538 that defines the opening 530b.

Each of the definition surfaces 538 is joined to the upper end face 536. The definition surfaces 538 face each other in the second direction. The definition surfaces 538 are inclined gradually closer to the lower end face 532 as the definition surfaces 538 approach each other.

The pressure relief valve 600 is provided in the case 500. The pressure relief valve 600 releases the pressure of the inside of the case 500. The pressure relief valve 600 opens when the pressure of the inside of the case 500 reaches a reference value or more. The pressure relief valve 600 includes a check valve. The pressure relief valve 600 is provided at a portion of the non-accommodation chamber S2 facing the opening 530b in the first direction. In the present embodiment, the pressure relief valve 600 is provided at a portion of the non-accommodation chamber S2 above a space between the first junction box 310 and the second junction box 320, that is, on the upper cover 520.

The respiratory membrane 700 is provided in the case 500. The respiratory membrane 700 adjusts the pressure of the inside of the case 500 by permitting gas to pass through the respiratory membrane 700 between the inside of the case 500 and the outside of the case 500. The respiratory membrane 700 is disposed on the opposite side of the pressure relief valve 600 from the side of the pressure relief valve 600 on which the respective electric power storage stacks 110, 120 are disposed. In the present embodiment, the respiratory membrane 700 is provided at a portion of the sidewall 514a facing the opening 530b. Specifically, the sidewall 514a is provided with a through-hole and the respiratory membrane 700 is provided on the outer surface of the sidewall 514a to cover the through-hole. Note that the respiratory membrane 700 may be provided at a portion of the sidewall 514a facing the respective electronic devices 331, 332.

In the electric power storage apparatus 1 according to the present embodiment described so far, the contact end face 530a of the partition wall 530 is in contact with the inner surface of the case body 501. Therefore, in a case where gas is discharged from any of the electric power storage stacks 110, 120 in the accommodation chamber S1, the gas proceeds to the non-accommodation chamber S2 through the opening 530b of the partition wall 530 and is discharged to the outside of the case 500 through the pressure relief valve 600 provided in the non-accommodation chamber S2. The path of the gas toward the pressure relief valve 600 is therefore restricted effectively.

Furthermore, the contact end face 530a of the partition wall 530 is in contact with the inner surface of the case body 501 and the junction boxes 310, 320 are disposed between the respective electronic devices 331, 332 and the opening 530b. Gas flowing into the non-accommodation chamber S2 through the opening 530b is therefore restrained from coming into contact with the respective electronic devices 331, 332.

In addition, gas (such as air) flowing into the non-accommodation chamber S2 through the respiratory membrane 700 and including oxygen is restrained from proceeding to the accommodation chamber S1 from a region other than the opening 530b after gas is discharged from the case 500.

Those skilled in the art would understand that the exemplary embodiment described above is specific examples of the following aspects.

### Aspect 1

An electric power storage apparatus including:
a plurality of first electric power storage stacks disposed side by side along a first direction;
a plurality of second electric power storage stacks disposed side by side along the first direction to face the first electric power storage stacks in a second direction orthogonal to both the first direction and an up-down direction;
a case configured to accommodate the first electric power storage stacks and the second electric power storage stacks; and
a pressure relief valve provided in the case, in which
the case includes
   a case body configured to accommodate the first electric power storage stacks and the second electric power storage stacks, and
   a partition wall provided in the case body, the partition wall facing the first electric power storage stacks and the second electric power storage stacks in the first direction,
the partition wall partitions inside of the case body into an accommodation chamber in which the first electric power storage stacks and the second electric power storage stacks are disposed and a non-accommodation chamber in which the first electric power storage stacks and the second electric power storage stacks are not disposed,
the partition wall includes
   a contact end face configured to come into contact with an inner surface of the case body, and
   an opening provided at a position facing a space in the first direction, the space being located between the first electric power storage stacks and the second electric power storage stacks, and
the pressure relief valve is provided at a portion of the non-accommodation chamber, the portion facing the opening in the first direction.

In the electric power storage apparatus, the contact end face of the partition wall is in contact with the inner surface of the case body. Gas generated from any of the electric power storage stacks in the accommodation chamber therefore proceeds to the pressure relief valve provided in the non-accommodation chamber through the opening of the partition wall. The path of the gas toward the pressure relief valve is therefore restricted effectively.

### Aspect 2

The electric power storage apparatus according to aspect 1, further including:
a first junction box disposed at a position in the non-accommodation chamber, the position facing the first electric power storage stack in the first direction across the partition wall; and
a second junction box disposed at a position in the non-accommodation chamber, the position facing the second electric power storage stack in the first direction across the partition wall and facing the first junction box at an interval in the second direction, in which
an upper surface of the first junction box and an upper surface of the second junction box are in contact with the case body.

In the aspect, when the internal pressure of the case body increases because gas is discharged from any of the electric power storage stacks, a gap is formed between the upper surfaces of the respective junction boxes and the upper cover to cause the gas to proceed to a space outside the respective junction boxes in the non-accommodation chamber in the second direction through the gap. That is, the space located outside functions as a pressure buffer region. This restrains the internal pressure of the case from sharply increasing when gas is discharged from any of the electric power storage stacks and restrains the case from being damaged because of the sharp increase.

### Aspect 3

The electric power storage apparatus according to aspect 2, further including:
a first electronic device disposed outside the first junction box in the second direction; and
a second electronic device disposed outside the second junction box in the second direction.

### Aspect 4

The electric power storage apparatus according to any of aspects 1 to 3, further including a bonding member configured to bond the case body and the partition wall together, in which
the case body includes
   a bottom wall located below the first electric power storage stacks and the second electric power storage stacks,
   a peripheral wall configured to surround the first electric power storage stacks and the second electric power storage stacks, and
   an upper cover configured to cover the first electric power storage stacks and the second electric power storage stacks, and
the contact end face includes
   a lower end face welded to the bottom wall,
   a side end face welded to the peripheral wall, and
   an upper end face connected to the upper cover with the bonding member between the upper end face and the upper cover.

In the aspect, gas discharged from an electric power storage stack is restrained from reaching the non-accommodation chamber through the region between the upper end face of the partition wall and the upper cover.

### Aspect 5

The electric power storage apparatus according to aspect 4, in which
the partition wall further includes a pair of definition surfaces each joined to the upper end face, the definition surfaces being configured to define the opening, and
the definition surfaces face each other in the second direction, the definition surfaces being inclined gradually closer to the lower end face as the definition surfaces approach each other.

Note that the embodiment disclosed herein should be understood as examples in all respects and should not be understood as being restrictive. The scope of the present disclosure is indicated by not the description of the embodiment described above, but the claims. Furthermore, the scope of the present disclosure includes the equivalents to the claims and all modifications within the scope of the claims.

What is claimed is:

1. An electric power storage apparatus comprising:
a plurality of first electric power storage stacks disposed side by side along a first direction;
a plurality of second electric power storage stacks disposed side by side along the first direction to face the first electric power storage stacks in a second direction orthogonal to both the first direction and an up-down direction;
a case configured to accommodate the first electric power storage stacks and the second electric power storage stacks; and
a pressure relief valve provided in the case, wherein
the case includes
a case body configured to accommodate the first electric power storage stacks and the second electric power storage stacks, and
a partition wall provided in the case body, the partition wall facing the first electric power storage stacks and the second electric power storage stacks in the first direction,
the partition wall partitions inside of the case body into an accommodation chamber in which the first electric power storage stacks and the second electric power storage stacks are disposed and a non-accommodation chamber in which the first electric power storage stacks and the second electric power storage stacks are not disposed,
the partition wall includes
a contact end face configured to come into contact with an inner surface of the case body, and
an opening provided at a position facing a space in the first direction, the space being located between the first electric power storage stacks and the second electric power storage stacks, and
the pressure relief valve is provided at a portion of the non-accommodation chamber, the portion facing the opening in the first direction.

2. The electric power storage apparatus according to claim 1, further comprising:
a first junction box disposed at a position in the non-accommodation chamber, the position facing the first electric power storage stack in the first direction across the partition wall; and
a second junction box disposed at a position in the non-accommodation chamber, the position facing the second electric power storage stack in the first direction across the partition wall and facing the first junction box at an interval in the second direction, wherein
an upper surface of the first junction box and an upper surface of the second junction box are in contact with the case body.

3. The electric power storage apparatus according to claim 2, further comprising:
a first electronic device disposed outside the first junction box in the second direction; and
a second electronic device disposed outside the second junction box in the second direction.

4. The electric power storage apparatus according to claim 1, further comprising a bonding member configured to bond the case body and the partition wall together, wherein
the case body includes
a bottom wall located below the first electric power storage stacks and the second electric power storage stacks,
a peripheral wall configured to surround the first electric power storage stacks and the second electric power storage stacks, and
an upper cover configured to cover the first electric power storage stacks and the second electric power storage stacks, and
the contact end face includes
a lower end face welded to the bottom wall,
a side end face welded to the peripheral wall, and
an upper end face connected to the upper cover with the bonding member between the upper end face and the upper cover.

5. The electric power storage apparatus according to claim 4, wherein
the partition wall further includes a pair of definition surfaces each joined to the upper end face, the definition surfaces being configured to define the opening, and
the definition surfaces face each other in the second direction, the definition surfaces being inclined gradually closer to the lower end face as the definition surfaces approach each other.
